(19) United States
(12) Patent Application Publication
(10) Pub. No.: US 2015/0169529 A1
(43) Pub. Date: Jun. 18, 2015

(54) MOBILE DEVICE DATA RENDERING

(71) Applicants: Rudolf Niessen, Speyer (DE); Christian Denkel, Joehlingen (DE)

(72) Inventors: Rudolf Niessen, Speyer (DE); Christian Denkel, Joehlingen (DE)

(73) Assignee: SAP AG, Walldorf (DE)

(21) Appl. No.: 14/107,107

(22) Filed: Dec. 16, 2013

(51) Int. Cl. G06F 17/24; G06F 17/22; H04L 29/08

(52) U.S. Cl. CPC G06F 17/246; H04L 67/10; G06F 17/2247

(57) ABSTRACT

Various embodiments herein include one or more of systems, method, software, and data structures that are utilized in presenting rows of data within user interfaces of mobile devices. Some embodiments include a presentation server that operates between a backend software system and a device app to obtain data from the backend system, transform and format the data according to a presentation template, and provide the data to the deice app. Other embodiments include the device app that receives formatted data from the presentation server and presents the data on a device according to the presentation template.

### BACKGROUND INFORMATION

Much data today is organized and stored in tables with many columns. Such data can be easily presented on a personal computer in a spreadsheet-like manner as displays are large and manipulation of user interfaces presenting data is quite easy through use of scroll bars and other controls. However, modern data consumers are utilizing a wide variety of devices to access, manipulate, and generate data that previously was only done on personal computers. Such devices generally include mobile devices, such as smartphones and tablets. Mobile devices have smaller displays and manipulation of user interfaces presented thereon can be cumbersome, especially when viewing data presented in a spreadsheet-like manner. To keep up with changing times, web pages and device apps have been adapted to present data on mobile devices in a more mobile device-friendly manner. However, there are many mobile devices and each mobile device has different display and manipulation properties. Thus, presentation and manipulation of data on mobile devices, although improved, has resulted in generalized solutions that are applicable to all mobile devices and do not allow tailoring to specific mobile devices. Regardless, such generalized, mobile device solutions are utilized as developing, tailoring, and maintaining user interfaces and data presentations specific to individual devices is expensive in terms of financial, resource, and time costs.

### BRIEF DESCRIPTION OF THE DRAWINGS

FIG. 1 is a logical block diagram of a system, according to an example embodiment.

FIG. 2 is a logical block diagram of a system, according to an example embodiment.

FIG. 3 illustrates an example portion of a presentation template, according to an example embodiment.

FIG. 4 illustrates a page including a rendering of a plurality of presentation template portions, according to an example embodiment.

FIG. 5 is a block flow diagram of a method, according to an example embodiment.

FIG. 6 is a block flow diagram of a method, according to an example embodiment.

FIG. 7 is a block diagram of a computing device, according to an example embodiment.

### DETAILED DESCRIPTION

Various embodiments herein include one or more of systems, method, software, and data structures that are utilized in presenting rows of data within user interfaces of mobile devices. Some such embodiments can be considered as spanning three layers of a technical data processing infrastructure: 1) a backend data processing system of an enterprise, such as an enterprise resource planning (ERP), customer relationship management (CRM), a customer retail system such as may provide multiple data views of various products offered by an enterprise, and the like; 2) a presentation server that operates between the backend system and mobile devices of users or customers to maintain stateful network sessions there between, to transform data of the backend system into mobile device presentation-friendly forms, and to proxy data processing requests from mobile devices to the backend system; and 3) mobile devices that present data to users and receive input with regard to data and data processing activities.

The mobile devices as described and illustrated herein include tablet computing devices, smartphones, handheld computing devices, and the like. However, mobile devices may also include apps that execute within web browsers, set-top boxes that connect to televisions, monitors, or other display devices, smart controllers within automobiles or home appliances, and other devices that are enabled to execute apps.

As mentioned above, a presentation server operates between a backend system and mobile devices of users. The presentation server in such embodiments is enabled to communicate with processes of the backend system to establish stateful data processing sessions with the backend system upon request from apps that execute on mobile devices. The presentation server includes presentation templates, stored in the presentation server or a template repository. The presentation templates include mappings between forms of data that are received from the backend system and how the data is to be presented within a mobile device app. Similarly, presentation templates may also include mappings between mobile device app events, such as data requests, data processing requests (i.e., show detail data, purchase a product, retrieve data, etc.) and processes, functions, services, and objects of the backend system. The mappings provide instructions to transform data, transform data requests, and perform other transforms of particular embodiments.

Typically, a presentation template stored by the presentation server or in a template repository includes an analog template that is present within a mobile device app or is retrievable thereby, such as from the template repository, or as may be provided to a mobile device app by the presentation server. A presentation template includes a generic user interface presentation structure including named fields that can be populated with data. The generic user interface presentation structure may be defined for presentation of a single row of data. Thus, when multiple rows of data are to be presented, multiple instances of the generic user interface presentation structure are instantiated and populated with data within a mobile device app.

A presentation template, in some embodiments, includes a default set of formatting properties for presentation of data within the named cells of the generic user interface presentation structure. Such formatting properties, for example, may include horizontal and vertical alignment properties, bold and italic text properties, font size and color properties, and other such formatting properties. In some embodiments, the default formatting properties of a presentation template may be overridden by formatting data included in a dataset received by a mobile device app from the presentation server. In such embodiments, the presentation server version of the presentation template, which is generally identical to the presentation template present within the mobile device app but includes the mappings and other elements as discussed previously, may include formatting property mappings. Thus, in a dataset provided by the presentation server to a mobile device app, the dataset may include formatting properties that will override any default formatting properties present in the presentation template of the mobile device app.

In a typical scenario, a mobile device app will connect to the presentation server over a network and request data. For example, the mobile device app may be an app of an airline through which users may request flight data of flights between two airports on a given day. The mobile device app may receive input within a user interface where the input identifies a date and two airports. The mobile device app transmits a representation of that data, via the network such as the Internet, to the presentation server in the form of a request. The presentation server, upon receipt of the request, may determine transforms that are needed according to a template associated with the request type. The transforms performed may include transforming a text form of the date to a DATE data form, among other possible data transformations. Based on the template associated with the request type, the presentation server also is able to identify a process, function, service, object, or other data processing element or structure to call within the backend system that is to process the request. The presentation server then transmits the request to the backend system and receives a response thereto. The backend system processes the request according to the called data processing element or structure, which is also typically the same data processing element or structure that may be called by other client applications or processes within the backend system. Thus, the presentation server and the presentation templates, among other things, enable development of mobile device apps that leverage existing backend system data processing processes and infrastructure and to minimize a number backend system data processing processes and infrastructure elements that perform similar or identical functions.

Continuing with this example, the presentation server, upon receipt of the response to the transformed request sent to the backend system, receives a dataset including data representative of flights between the two cities on the specified date. This will typically include multiple rows of data—a row for each flight, each row including data representative of a departure time and an arrival time and an airline operating the given flight. The data for each row may include additional data, such as a cost of the respective flight, a number of frequent flier miles that will be obtained by taking the flight, and other such data. The presentation server, based on the received data and, in some embodiments, the requesting mobile device app, identifies a presentation template to apply to the received data. The presentation template is then applied and a message including the transformed data is generated. The message, in some embodiments, includes data encoded according to a format parsable by the mobile device app. For example, the data may be encoded in a markup language, such as extensible markup language (XML). The encoded data is encoded according to not only data transformations of the presentation template, but also to associate columns of data to named fields of a generic user interface presentation structure of the presentation template and to add any formatting properties that may be included in the presentation template used by the presentation server. The message is then transmitted to the mobile device app.

The mobile device app, upon receipt of the message include the requested data identifies and retrieves the presentation template within which the data is to be presented. The encoded data of the message is then parsed, extracted, and populated into the generic user interface presentation structure of the template. The data is then formatted according to any formatting data included in the message and according to default formatting properties that may be included in the presentation template. In some embodiments, the mobile device app may perform additional processing or formatting of the data to be presented or the presentation template according to specific properties of the mobile device on which the mobile device app is present. For example, the display of the mobile device may be of a resolution that allows for or may benefit from presentation of the data in a different manner. The mobile device app may be developed to account for such device-specific properties. The data may then be presented on a display of the mobile device.

These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

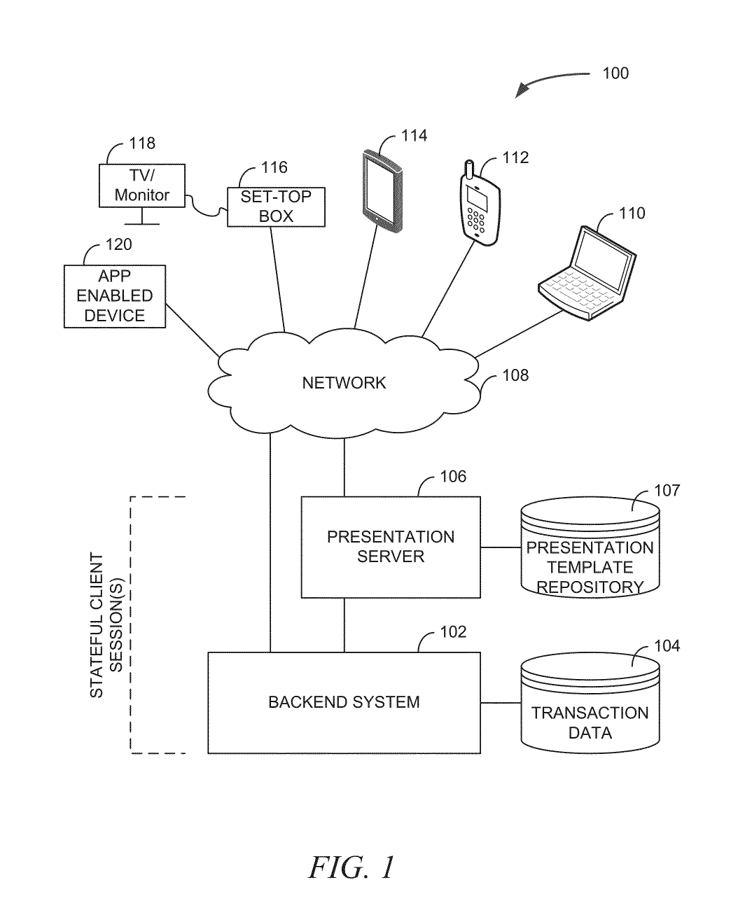

FIG. 1 is a logical block diagram of a system 100, according to an example embodiment. The system 100 is an example computing environment within which various embodiments may be implemented.

The system 100 includes a backend system 102 of an enterprise, such as one or more of an enterprise resource planning (ERP), customer relationship management (CRM), human resources management (HRM), a transaction processing system, a customer retail system such as may provide multiple data views of various products offered by an enterprise, an order and order processing system, a banking system, and the like. The backend system 102 stores and processes transaction data 104 as may be stored in a database, data files, and other data storage processes and devices.

The backend system 102 may be deployed to one or more computing devices, such as one or more enterprise-class server computers, virtual machines, and the like. The backend system 102 may be accessed by other systems and programs that execute and various computing devices throughout the system 100. For example, the backend system 102 may be accessed via a network 108 by thick-client or thin-client applications as may be deployed to personal computers 110, by other software systems, and other clients. The backend system 102 may also be accessed by a presentation server 106 either directly or via the network 108.

As discussed above, the presentation server 106 operates in the networked environment of the system 100 between the backend system 102 and mobile devices 112, 114, 116, 120 of users, although the presentation server 106 may also operate with web browser apps as may be deployed to web browser applications of personal computers 110 and other computing devices. The presentation server 106 in such embodiments communicates with processes of the backend system 102 to establish stateful data processing sessions with the backend system 102 upon request from apps that execute on mobile devices 112, 114, 116, 120. The presentation server 106 may be deployed as an add-on module to the backend system 102 and operate on the same or different hardware thereof, in some embodiments. However, in other embodiments, the presentation server 106 may be deployed as a standalone program that executes on one or more distinct computing devices or virtual machines from the backend system 102. In some embodiments, the presentation server 106 is hosted by a third party, such as in a cloud-computing type arrangement.

The presentation server 106 includes presentation templates, stored in the presentation server 106 or a template repository 107. The presentation templates include mappings between forms of data that are received from the backend system 102 and how the data is to be presented within a mobile device 112, 114, 116, 120 app. Similarly, presentation templates may also include mappings between mobile device 112, 114, 116, 120 app events, such as data requests, data processing requests (i.e., show detail data, purchase a product, retrieve data, etc.) and processes, functions, services, and objects of the backend system 102. The mappings provide instructions to transform data, transform data requests, and perform other transforms of particular embodiments.

The network 108 is generally a network capable of transporting data between computing devices of the various functional data processing elements of the system 100, such as the backend system 102, the presentation server 106, personal computers 110 and the various mobile devices 112, 114, 116, 120. The network 108 may include both wired and wireless connections. The network 108 is intended to represent one or more of virtually any type of network capable of transporting data as described, such as one or more of a local area network, a wide area network, a system area network, a value added network, a virtual private network, the Internet, and other such networks.

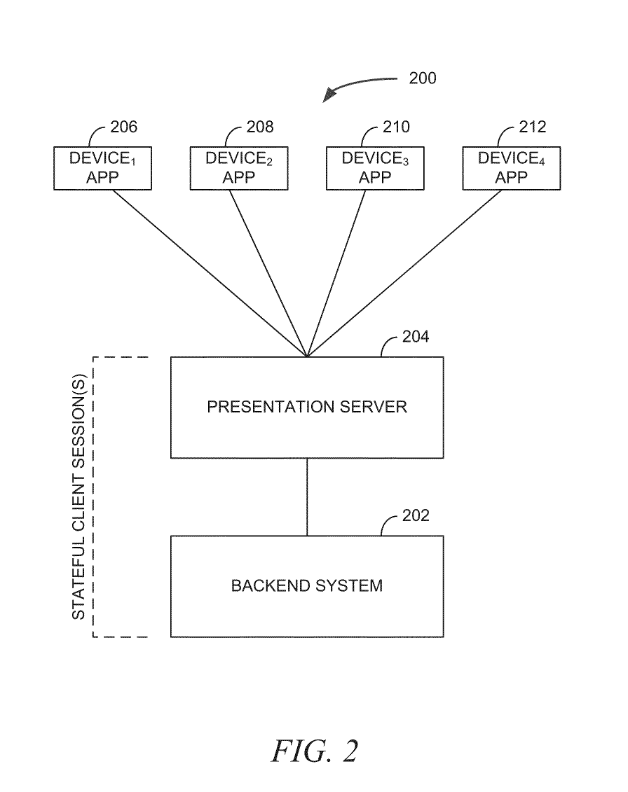

FIG. 2 is a logical block diagram of a system 200, according to an example embodiment. The example embodiment includes a plurality of device apps₁₋₄ 206, 208, 210, 212. Although there are four device apps illustrated, other embodiments may include one, two, three, or more device apps. Each device app 206, 208, 210, 212 is generally an instance of the same app, although each device app 206, 208, 210, 212 is tailored for a different device-type, such as devices being different of one or more of different operating systems, different component types (e.g., operating system or version, display sizes and resolutions, input devices, processing power, bandwidth speeds, etc.).

As described above, each device app 206, 208, 210, 212 may include or have access to presentation templates to use in presenting data received from a presentation server 204. While the presentation templates include data, including a generic user interface presentation structure having named fields that can be populated with data of a single row of data and can be instantiated a number of times within a user interface equal to a number of rows of data to be presented, the presentation templates, being generic, are not necessarily tailored to the specific device on which the device app 206, 208, 210, 212 is deployed. Thus, each device app 206, 208, 210, 212 may include tailoring options, added when the mobile device app 206, 208, 210, 212 is developed or later by a download of data. The tailoring options may tailor specific presentation templates or may tailor presentation templates generally to allow for better presentation of data within presentation templates. For example, such tailoring may be performed to accommodate for a width or resolution of a display of a particular mobile device. Other tailoring may also, or alternatively, be provided for.

The presentation server 204 operates between a backend system 202 and devices on which the device apps 206, 208, 210, 212 are deployed. The presentation server 204 communicates with processes of the backend system 202 to establish stateful data processing sessions with the backend system 202 upon request from one of the device apps 206, 208, 210, 212. The presentation server 204 includes the presentation templates, which may be stored in the presentation server 204 or a template repository, such as template repository 107 of FIG. 1. The presentation templates include mappings between forms of data that are received from the backend system 202 and how the data is to be presented within the device apps 206, 208, 210, 212. Similarly, presentation templates may also include mappings between device apps 206, 208, 210, 212 events, such as data requests, data processing requests (i.e., show detail data, purchase a product, retrieve data, etc.) and processes, functions, services, and objects of the backend system. The mappings provide instructions the presentation server for transforming data, transforming data requests, and performing other transforms of particular embodiments.

The stateful data processing sessions between the presentation server 204 and the backend system 202 are maintained while a device app 206, 208, 210, 212 is viewing or manipulating data, although such sessions may timeout after a period of inactivity. The stateful data sessions are stateful in the sense that a presentation server may hold certain types of transactions open while awaiting further input from a device app 206, 208, 210, 212, such as to purchase a presented product, the provisioning of payment data, to await confirmation input before committing data manipulation (i.e., create, update, or delete), and the like.

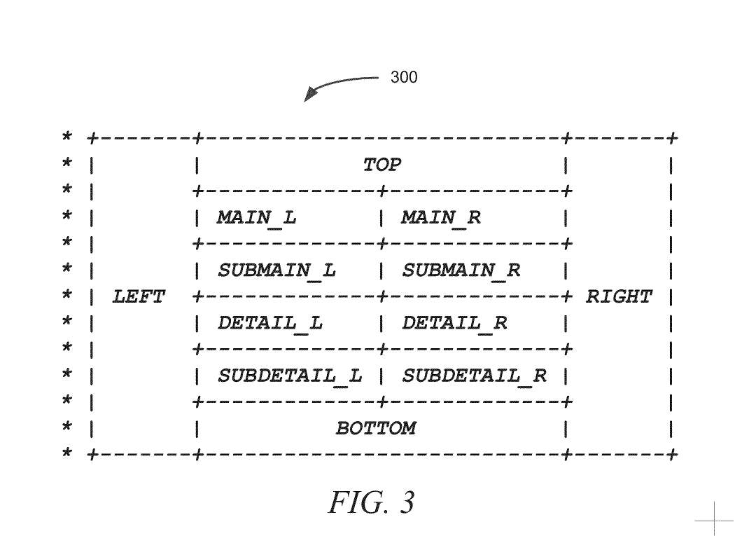

FIG. 3 illustrates an example portion 300 of a presentation template, according to an example embodiment. The example portion 300 of the presentation template illustrates an example generic user interface presentation structure including named fields that can be populated with data. The generic user interface presentation structure may be defined for presentation of a single row of data. Thus, when multiple rows of data are to be presented, multiple instances of the generic user interface presentation structure are instantiated and populated with data within a device app.

The generic user interface presentation structure includes named fields as follows:

LEFT
RIGHT
TOP
MAIN_L
MAIN_R
SUBMAIN_L
SUBMAIN_R
DETAIL_L
DETAIL_R
SUBDETAIL_L
SUBDETAIL_R
BOTTOM

Each of the named fields is a field that can receive and present data when instantiated within a user interface. When a device app receives data from presentation server, the received data may identify a presentation template within which to present data of the message and a mapping of data elements of the message to named fields of a generic user interface presentation structure of the identified presentation template, such as is illustrated in FIG. 3. However, in some embodiments, a received message may not identify a presentation template. In such instances, the device app will identify a presentation template based on one or more factors, such as may be based on the received data, a process from which the data originated in the backend system, a particular presentation server or process thereof from which the message was received, a configuration setting of the device app, tailoring data of the device app, and other factors.

The presentation template of which the illustrated generic user interface presentation structure is a part of may include default data mapping and formatting specifications that will be applied to received data when a message including the data does not specify one or both of a mapping of data elements the named fields or formatting properties. An example of such data mapping and formatting specifications is provided in TABLE 1. For example, data columns included in an encoded dataset are received in an order, such as within a dataset encoded according to an XML schema. The first data column is mapped to named field MAIN_L of the illustrated generic user interface presentation structure of FIG. 3. The font size and style in that named field is BIG and BOLD. However, when a received message includes equivalent data of TABLE 1, the data included in the message will override the default data when the data is rendered within the generic user interface presentation structure. Additionally, in instances where a message does not include data to populate all fields, the non-populated fields of the generic user interface presentation structure typically will not be presented.

TABLE 1

| DATA COLUMN | POSITION | FONTSIZE | FONTSTYLE |
|---|---|---|---|
| 1 | MAIN_L | BIG | BOLD |
| 2 | MAIN_R | BIG | BOLD |
| 3 | SUBMAIN_L | MEDIUM | NORMAL |
| 4 | SUNMAIN_R | MEDIUM | NORMAL |
| 5 | DETAIL_L | SMALL | NORMAL |
| 6 | DETAIL_R | SMALL | NORMAL |
| 7 | SUBDETAIL_L | SMALL | NORMAL |
| 8 | SUBDETAIL_R | SMALL | NORMAL |
| 9 | TOP | BIG | BOLD |
| 10 | BOTTOM | BIG | NORMAL |
| 11 | LEFT | BIG | BOLD |
| 12 | RIGHT | BIG | NORMAL |

Additionally, the data of TABLE 1, or equivalent data of another presentation template with regard to another generic user interface presentation structure, or data as specified in a message received from a presentation server, may include additional columns. For example, another column may be included to specify a control type, data options to be presented in the control type, and labels for each of the different options. For example, a control column may specify a drop-down-list-box and the options may specify YES, NO, MAYBE. The control of that type would then be rendered at an appropriate time with the YES, NO, MAYBE options included therein.

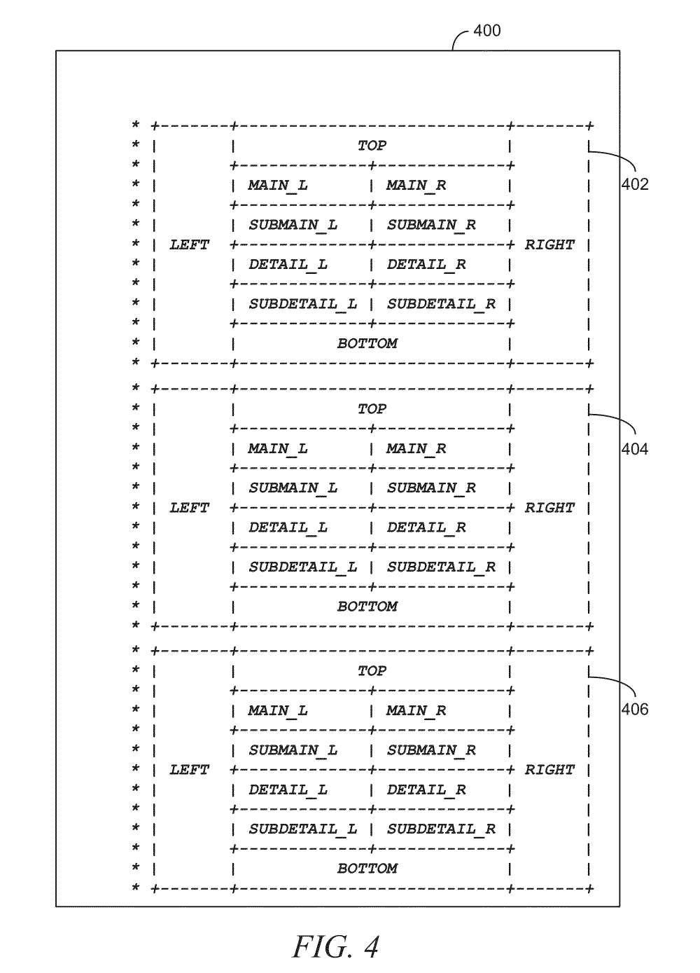

FIG. 4 illustrates a page 400 including a rendering of a plurality of presentation template portions, according to an example embodiment. More specifically, the page is a device app user interface within which multiple example portions 300 of the presentation template described in FIG. 3 are illustrated, such as will happen when a message received from a presentation server by a device app includes a plurality of data rows. As illustrated, each of illustrated portions 402, 404, 406 are instances of the generic user interface presentation structure illustrated in FIG. 3. Each portion 402, 404, 406 will present a row of received data and will be formatted, such as according to the mapping and formatting included in TABLE 1 above.

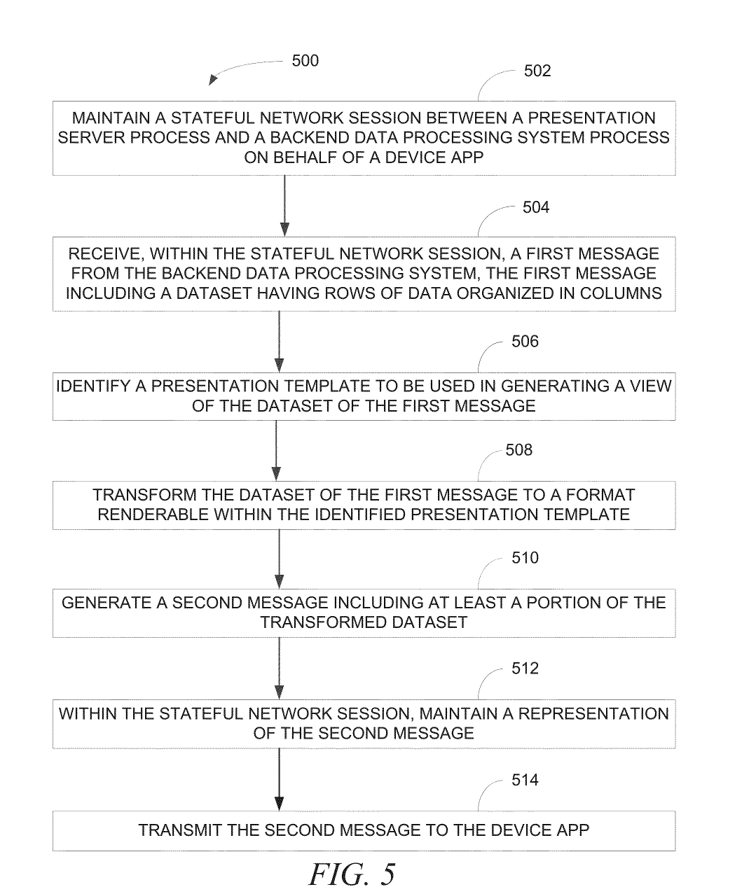

FIG. 5 is a block flow diagram of a method 500, according to an example embodiment. The method 500 is an example of a method that may be performed by a presentation server 106 of FIG. 1 or 204 of FIG. 2. The method 200 includes maintaining 502 a stateful session between a presentation server process and a backend data processing system process on behalf of a device app. The method 500 may then receive 504, within the stateful session, a first message from the backend data processing system. The received 504 first message includes a dataset having rows of data organized in columns. The method 500 may then identify 506 a presentation template to be used in generating a view of the dataset of the first message and transform 508 the dataset to a format renderable within the identified presentation template. The method 500 may then generate 510 a second message including at least a portion of the transformed dataset and transmit 514 the second message, via a network, to the device app. In some embodiments, the method may maintain 512, within the stateful session, a representation of the second message.

In some embodiments of the method, the first message is received 504 with a presentation template identifier. When the first message includes the presentation template identifier, the method 500 identifies 506 the presentation template based at least in part on the presentation template identifier.

In a further embodiment of the method 500, transforming 508 the dataset of the first message to the format renderable within the identified presentation template includes generating a markup language representation of at least some data columns of each row of data included in the dataset of the first message. The markup language, in some embodiments, is XML. In other embodiments, the markup language is a proprietary markup language while in other embodiments, the markup language is another open standards-based markup language.

In yet another embodiment, the transforming 508 of the dataset of the first message to the format renderable within the identified presentation template further includes applying a formatting template. Application of the formatting template specifies, within the generated markup language representation, formatting properties with regard to presentation of at least data column when rendered according to the identified presentation template.

In some such embodiments, and others, the identified 506 presentation template includes a set of named cells within which data is presentable, such as is illustrated in FIG. 3. Further, generating the markup language representation of at least some data columns of each row of data included in the dataset of the first message includes mapping, in the markup language representation, each of the at least some data columns to a named cell of the identified presentation template. The presentation template in such embodiments, may be a row template, which when rendered, is rendered by a device app a number of times equal to a number of rows included in the dataset of the first message.

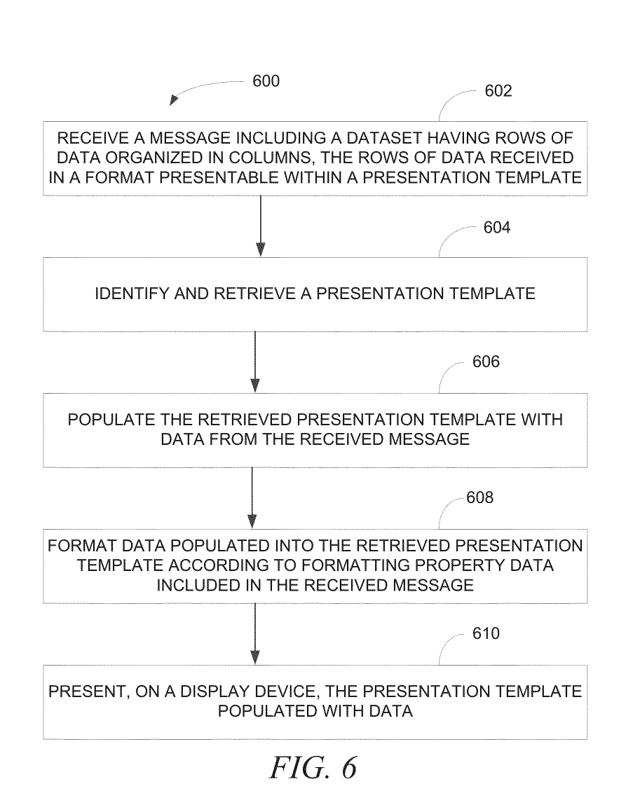

FIG. 6 is a block flow diagram of a method 600, according to an example embodiment. The method 600 is an example of a method that may be performed by a device app.

The method 600 includes receiving 602, via a network from a presentation server, a message including a dataset having rows of data organized in columns. The rows of received data are received in a format presentable within a presentation template, such as may be provided in a markup language message. The method 600 may then identify and retrieve 604 a presentation template to be used in presenting a view of the received data. The template may be retrieved from memory of a device on which an app performing the method may execute, such as may be included in data of the app, or may be retrieved from another data storage location, such as the presentation server.

The method 600 may then populate 606 the retrieved presentation template with data from the received message and format 608 the data populated into the retrieved presentation template according to formatting property data included in the received message. The method 600 then presents 610, on a display of the device, the presentation template populated with data.

After the presentation template populated with data is presented, the method 600 may further include receiving event input with regard to a presented data element. The method 600 may then generate and transmit, via the network, a request including an identifier of the event, such as a selection for a view of detail data, and a representation of the data element that was received with regard to the event input. The method 600 then receives, in response to the request, a second message including a dataset having a single row of data organized in columns, the single row of data received in a format presentable in a second presentation template.

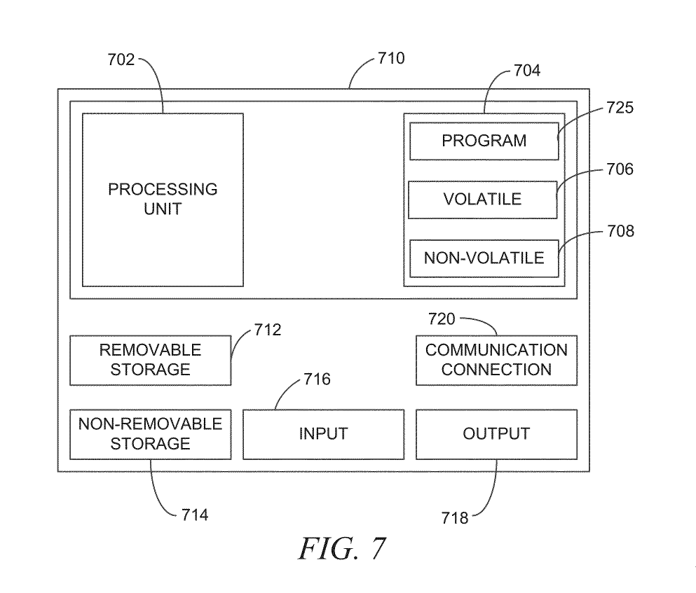

FIG. 7 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 710, may include a processing unit 702, memory 704, removable storage 712, and non-removable storage 714. Although the example computing device is illustrated and described as computer 710, the computing device may be in different forms in different embodiments. For example, the computing device may instead be a smartphone, a tablet, or other computing device including the same or similar elements as illustrated and described with regard to FIG. 7. Further, although the various data storage elements are illustrated as part of the computer 710, the storage may also or alternatively include cloud-based storage accessible via a network, such as the Internet.

Returning to the computer 710, memory 704 may include volatile memory 706 and non-volatile memory 708. Computer 710 may include—or have access to a computing environment that includes a variety of computer-readable media, such as volatile memory 706 and non-volatile memory 708, removable storage 712 and non-removable storage 714. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 710 may include or have access to a computing environment that includes input 716, output 718, and a communication connection 720. The input 716 may include one or more of a touchscreen, touchpad, mouse, keyboard, camera, and other input devices. The computer may operate in a networked environment using a communication connection 720 to connect to one or more remote computers, such as database servers, web servers, and other computing device. An example remote computer may include a personal computer (PC), server, router, network PC, a peer device or other common network node, or the like. The communication connection 720 may be a network interface device such as one or both of an Ethernet card and a wireless card or circuit that may be connected to a network. The network may include one or more of a Local Area Network (LAN), a Wide Area Network (WAN), the Internet, and other networks.

Computer-readable instructions stored on a computer-readable medium are executable by the processing unit 702 of the computer 710. A hard drive (magnetic disk or solid state), CD-ROM, and RAM are some examples of articles including a non-transitory computer-readable medium. For example, various computer programs or apps, such as one or more applications and modules implementing one or more of the methods illustrated and described herein or an app or application that executes on a mobile device or is accessible via a web browser, may be stored on a non-transitory computer-readable medium.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
maintaining a stateful session between a presentation server process and a backend data processing system process on behalf of a device app;
receiving, within the stateful session, a first message from the backend data processing system, the first message including a dataset having rows of data organized in columns;
identifying a presentation template to be used in generating a view of the dataset of the first message;
transforming the dataset of the first message to a format renderable within the identified presentation template;
generating a second message including at least a portion of the transformed dataset;
within the stateful session, maintaining a representation of the second message; and
transmitting the second message, via a network, to the device app.

2. The method of claim 1, wherein:
the first message further includes a presentation template identifier; and
identifying the presentation template includes identifying the presentation template based at least in part on the presentation template identifier.

3. The method of claim 1, wherein transforming of the dataset of the first message to the format renderable within the identified presentation template includes generating a markup language representation of at least some data columns of each row of data included in the dataset of the first message.

4. The method of claim 3, wherein transformation the dataset of the first message to the format renderable within the identified presentation template further includes applying a formatting template, the application of which specifies, within the generated markup language representation, formatting properties with regard to presentation of at least data column when rendered according to the identified presentation template.

5. The method of claim 4, wherein formatting properties with regard to presentation of data columns not specified in the formatting template are formatted according to default formatting properties of the identified presentation template when rendered according to the identified presentation template.

6. The method of claim 3, wherein:
the identified presentation template includes a set of named cells within which data is presentable;
generating the markup language representation of at least some data columns of each row of data included in the dataset of the first message includes mapping, in the markup language representation, each of the at least some data columns to a named cell of the identified presentation template; and
the identified presentation template is a row template, which when rendered, is rendered a number of times equal to a number of rows included in the dataset of the first message.

7. The method of claim 6, wherein cells of the set of named cells of the presentation template that do not include a mapped data column within the markup language representation are omitted from a visual rendering generated based on the second message and the identified presentation template.

8. A non-transitory computer-readable medium, with instructions stored thereon, which when executed by at least one processor of a computing device, cause the computing device to:
receive, via a network from a presentation server, a message including a dataset having rows of data organized in columns, the rows of data received in a format presentable within a presentation template;
identify and retrieve a presentation template;
populate the retrieved presentation template with data from the received message;
format data populated into the retrieved presentation template according to formatting property data included in the received message; and
present, on a display device, the presentation template populated with data.

9. The non-transitory computer-readable medium of claim 8, wherein data populated into the retrieved presentation template for which formatting data is not applied is formatted according to formatting properties of the presentation template.

10. The non-transitory computer-readable medium of claim 8, further comprising:
receive event input, the event input received with regard to a data element included in the presentation of the template populated with data;
generate and transmit, via the network, a request including an identifier of the event and a representation of the data element that was received with regard to the event input;
receive, in response to the request, a second message including a dataset having a single row of data organized in columns, the single row of data received in a format presentable in a second presentation template.

11. The non-transitory computer-readable medium of claim 10, further comprising:
identify and retrieve a second presentation template from the data storage;
populate the retrieved second presentation template with data from the received second message; and
present, on the display device, the presentation second template populated with data from the received second message.

12. The non-transitory computer-readable medium of claim 8, wherein the presentation template is retrieved from the non-transitory computer-readable medium.

13. The non-transitory computer-readable medium of claim 12, wherein:
the non-transitory computer-readable medium stores a plurality of presentation templates, each presentation template including a template identifier; and
data of the received message includes a template identifier of the presentation template to identify and retrieve.

14. The non-transitory computer-readable medium of claim 12, wherein the non-transitory computer-readable medium is a non-volatile memory of a computing device.

15. A system comprising:
at least one processor;
at least one memory;
at least one network interface; and
an instruction set accessible in the memory and executable by the at least one processor to:
maintain a stateful network session between the system and a backend data processing system process on behalf of a device app;
receive, via the at least one network interface within the stateful network session, a first message from the backend data processing system, the first message including a dataset having rows of data organized in columns;
identify a presentation template to be used in generating a view of the dataset of the first message;
transform the dataset of the first message to a format renderable within the identified presentation template;
generate a second message including at least a portion of the transformed dataset;
within the stateful network session, maintain a representation of the second message; and
transmit the second message, via a network, to the device app.

16. The system of claim 15, wherein:
the first message further includes a presentation template identifier; and
identifying the presentation template includes identifying the presentation template based at least in part on the presentation template identifier.

17. The system of claim 15, wherein transforming of the dataset of the first message to the format renderable within the identified presentation template includes generating a markup language representation of at least some data columns of each row of data included in the dataset of the first message.

18. The system of claim 17, wherein transformation the dataset of the first message to the format renderable within the identified presentation template further includes applying a formatting template, the application of which specifies, within the generated markup language representation, formatting properties with regard to presentation of at least data column when rendered according to the identified presentation template.

19. The system of claim 18, wherein formatting properties with regard to presentation of data columns not specified in the formatting template are formatted according to default formatting properties of the identified presentation template when rendered according to the identified presentation template.

20. The system of claim 17, wherein:
the identified presentation template includes a set of named cells within which data is presentable;
generating the markup language representation of at least some data columns of each row of data included in the dataset of the first message includes mapping, in the markup language representation, each of the at least some data columns to a named cell of the identified presentation template; and
the identified presentation template is a row template, which when rendered, is rendered a number of times equal to a number of rows included in the dataset of the first message.
